(19) United States
(12) Patent Application Publication
(10) Pub. No.: US 2026/0299501 A1
(43) Pub. Date: Oct. 1, 2026

(54) CONTROL DEVICE, IMAGE FORMING SYSTEM, AND CONTROL METHOD

(71) Applicant: Konica Minolta, Inc., Tokyo (JP)

(72) Inventor: Hiroshi Shimura, Tokyo (JP)

(73) Assignee: Konica Minolta, Inc., Tokyo (JP)

(21) Appl. No.: 19/543,141

(22) Filed: Feb. 18, 2026

(30) Foreign Application Priority Data
Mar. 26, 2025 (JP) 2025-051461

(51) Int. Cl. G03G 15/00

(52) U.S. Cl. CPC G03G 15/6582; G03G 15/5062; G03G 15/652; G03G 15/6523; G03G 2215/00759; G03G 2215/00814; G03G 2215/00818

(57) ABSTRACT

A control device includes a controller that determines, in a case where post-processing is performed on a sheet on which an image is formed, a printing position of a reference mark with respect to the image; and gives an instruction to print the reference mark based on the determined printing position. The controller determines the printing position of the reference mark based on a type of the post-processing.

### CROSS REFERENCE TO RELATED APPLICATIONS

This application is based on Japanese Patent Application No. 2025 − 051461 filed in Japanese on Mar 26, 2025, the contents of which are incorporated herein by reference.

### BACKGROUND OF THE INVENTION

### Technical Field

The present invention relates to a control device, an image forming system, and a control method. In particular, the present invention relates to a technique for performing post-processing on a sheet on which an image has been formed.

### Description of Related Art

In the related art, a control device that controls an operation when an image such as a label is printed on a roll-shaped continuous sheet is known. Such a conventional control device is described in, for example, Japanese Unexamined Patent Publication No. JP2019-181718A. When a large number of images are printed on a continuous sheet, the control device prints the images with reference marks provided near the images. The reference mark is used as a reference position for punching an image from a sheet in a post-processing step. In other words, when punching a sheet, the post-processing device detects a reference mark printed on the sheet, and extracts an image from the sheet with reference to the position of the reference mark.

Incidentally, as a post-processing device which performs punching processing on a sheet, there are various types of devices such as a type which uses a flat plate-like cutting die and a type which uses a curved surface-like cutting die. The post-processing device using the plate-like cutting die intermittently conveys the continuous sheet, drives the plate-like cutting die at a timing when the sheet conveyance is stopped, and cuts out the image from the sheet. In the post-processing device using the curved surface cutting die, the curved surface cutting die is attached to the surface of a rotating roller, and the cutting die is rotated in synchronization with the sheet conveyance, thereby extracting the image from the sheet.

In these types of punching, it is necessary to keep the cutting accuracy of the image within a predetermined range. If the punching position is significantly shifted, the image punched from the sheet becomes a defective image and has to be discarded.

Here, the post-processing device using the flat plate-like cutting die can enhance the cutting accuracy if there is a reference mark in the center of the image to be subjected to the punching processing in the conveying direction of the sheet. Furthermore, a post-processing device that uses a curved surface cutting die can increase cutting accuracy if there is a reference mark on the leading end side of an image to be cut in the conveyance direction of a sheet.

However, the conventional control device determines the printing position of the reference mark without considering the type of the post-processing. For this reason, the conventional control device has a problem in that the cutting accuracy is reduced depending on the type of post-processing, and a large amount of discarded images is generated.

### SUMMARY OF THE INVENTION

The present invention has been devised in order to solve the above-described conventional problems. That is, an object of the present invention is to provide a control device, an image forming system, and a control method capable of, in a case where post-processing is performed on a sheet on which an image has been formed, forming a reference mark at a position where the accuracy of the post-processing does not decrease.

In order to achieve the above object, according to an aspect of the present invention, a control device includes a controller that determines, in a case where post-processing is performed on a sheet on which an image is formed, a printing position of a reference mark with respect to the image, and gives an instruction to print the reference mark based on the determined printing position. The controller determines the printing position of the reference mark based on a type of the post-processing.

### BRIEF DESCRIPTION OF THE DRAWINGS

The advantages and features provided by one or more embodiments of the invention will become more fully understood from the detailed description given herein below and the appended drawings which are given by way of illustration only, and thus are not intended as a definition of the limits of the present invention.

FIG. 1 is a diagram illustrating an example of a configuration of an image forming system;

FIGS. 2A and 2B are diagrams illustrating printing positions of reference marks by the image forming apparatus;

FIG. 3 is a diagram illustrating a hardware configuration and a functional configuration of a control device;

FIG. 4 is a flowchart illustrating an example of a processing procedure by a controller;

FIG. 5 is a diagram illustrating an example of post-processing information;

FIG. 6 is a diagram illustrating a selection screen for a post-processing device;

FIG. 7 is a diagram illustrating a position adjustment screen for a printing position of a reference mark;

FIGS. 8A and 8B are diagrams illustrating two patterns related to additional printing;

FIG. 9 is a flowchart illustrating an example of a processing procedure by the controller when the additional printing is performed; and

FIG. 10 is a diagram showing a position adjustment screen relating to the printing position of the second image.

### DETAILED DESCRIPTION OF EMBODIMENTS

Hereinafter, one or more embodiments of the present invention will be described with reference to the drawings. However, the scope of the invention is not limited to the disclosed embodiments. Note that in the embodiments described below, common elements are denoted by the same reference signs, and redundant description thereof is omitted.

### Image Forming System

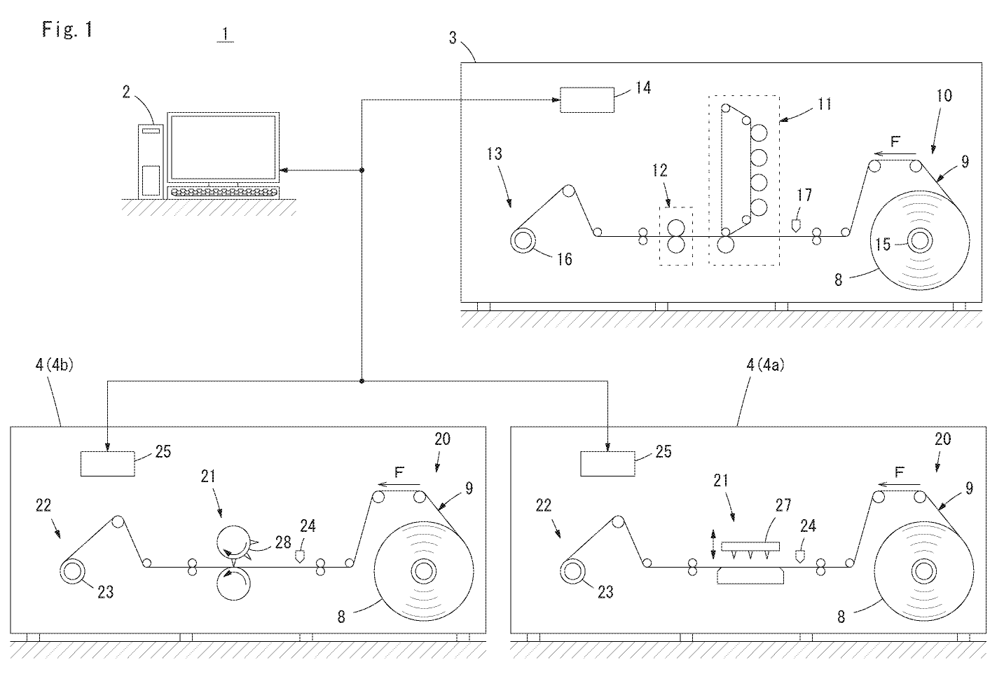

FIG. 1 illustrates an example of the configuration of an image forming system 1 according to an embodiment of the present invention. The image forming system 1 is a system that prints a plurality of images on a sheet 9 such as a print sheet at regular intervals and then performs a punching process of punching each of the plurality of images printed on the sheet 9 into one image in post-processing. The image forming system 1 includes a control device 2, an image forming apparatus 3, and a plurality of post-processing device 4.

The image forming apparatus 3 feeds a long continuous sheet 9 wound in a roll shape, forms a plurality of images at regular intervals on the continuously conveyed sheet 9, and again winds the sheet 9 on which the plurality of images is printed in a roll shape to collect the sheet 9. The image to be printed on the long continuous sheet 9 is, for example, a label or a business card.

As illustrated in FIG. 1, the image forming apparatus 3 includes a sheet feed section 10, an image forming section 11, a fixing section 12, a collecting section 13, and a controller 14. The sheet feed section 10 holds a sheet roll 8 in which a long sheet 9 is wound around a winding core 15, and continuously feeds the sheet 9 from the sheet roll 8. The sheet 9 is conveyed along a conveyance direction F in a conveyance path formed inside the image forming apparatus 3. In the conveyance path, the mark detection sensor 17, the image forming section 11, and the fixing section 12 are arranged in this order along the conveyance direction F.

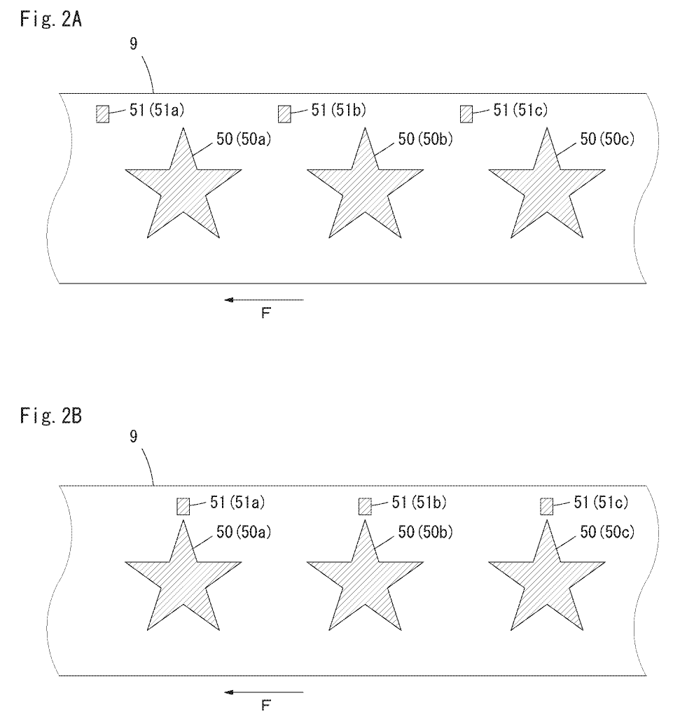

The mark detection sensor 17 is a sensor that detects reference marks 51 (refer to FIG. 2A and FIG. 2B) printed on the sheet 9. The mark detection sensor 17 functions when a sheet 9 on which a plurality of images has already been printed is supplied from the sheet feed section 10 and additional printing is to be performed on the sheet 9. Next, the mark detection sensor 17 detects the position of a reference mark 51 added in the vicinity of the image already printed, and determines the printing position of the additional printing image. The additional printing by the image forming apparatus 3 will be described later.

The image forming section 11 forms a plurality of images at regular intervals on the sheets 9 continuously supplied from the sheet feed section 10. For example, the image forming section 11 generates toner images of respective colors such as Y (yellow), M (magenta), C (cyan), and K (black), and generates a color image by superimposing these toner images. Then, the image forming section 11 transfers the color image onto the sheet 9 to form an image on the sheet 9.

When forming a plurality of images on the sheet 9, the image forming section 11 adds the reference mark 51 to each of the plurality of images and prints the images. The reference mark 51 is a mark indicating a reference position for punching in the post-processing device 4.

The fixing section 12 fixes the image transferred onto the sheet 9 to the sheet 9. For example, the fixing section 12 performs a heating process and a pressurizing process on the sheet 9 to which the toner image is transferred, thereby melting the toner and fixing the toner to the sheet 9. Incidentally, in the present embodiment, the case where the image is formed on the sheet 9 by the electrophotographic method is exemplified, but the present invention is not limited thereto. For example, the image forming section 11 may form an image on the sheet 9 by an inkjet method.

The collecting section 13 collects the long sheet 9 on which a plurality of images has been printed by winding it around a winding core 16. Controller 14 controls the above-described operation of image forming apparatus 3. For example, the controller 14 can communicate with the control device 2, and controls the operation of the image forming apparatus 3 based on an instruction from the control device 2.

The post-processing device 4 performs post-processing on the sheet 9 on which the images have been printed by the image forming apparatus 3. The post-processing performed by the post-processing device 4 is a punching process of punching out a plurality of images printed on the sheet 9 from the sheet 9. By this punching process, each of the plurality of images is separated from the sheet 9.

The image forming system 1 shown in FIG. 1 includes two post-processing devices 4a and 4b as the post-processing device 4. The post-processing to be performed on the sheet 9 on which the plurality of images has been printed is performed using any one of the two post-processing devices 4a and 4b. The image forming system 1 may include three or more post-processing device 4. In this case, the image forming system 1 selects one of the three or more post-processing device 4 to perform post-processing.

The post-processing device 4a includes a sheet feed section 20, a punching section 21, a collecting section 22, and a controller 25. The sheet feed section 20 holds a sheet roll 8 around which a sheet 9 on which the images are printed is wound, and continuously feeds the sheet 9 from the sheet roll 8. The sheet 9 is conveyed along a conveyance direction F in a conveyance path formed inside the post-processing device 4a. In the conveyance path, the mark detection sensor 24, the punching section 21, and the collecting section 22 are disposed in order along the conveyance direction F.

The mark detection sensor 24 is a sensor that detects reference marks 51 (refer to FIG. 2A and FIG. 2B) printed on the sheet 9. The controller 25 controls the punching operation of the punching section 21 based on the positions of the reference marks 51 detected by the mark detection sensor 24.

The punching section 21 of the post-processing device 4a includes a flat plate-shaped cutting die 27. That is, the post-processing device 4a performs punching using the flat plate-shaped cutting die 27. The controller 25 cuts out at least one image printed on the sheet 9 by vertically driving the flat plate-shaped cutting die 27 in a state where the conveyance of the sheet 9 is temporarily stopped. For example, the flat plate-shaped cutting die 27 can cut a predetermined number of images (for example, about three images) at a time. Therefore, the controller 25 repeats the operation of intermittently conveying the sheet 9 and driving the flat plate-shaped cutting die 27 in accordance with the length of a predetermined number of images to be cut out by the flat plate-shaped cutting die 27. At this time, the controller 25 determines the stop position of the sheet 9 based on the reference mark 51 detected by the mark detection sensor 24. This stop position defines cutting accuracy in the post-processing device 4a.

The sheet 9 from which the images have been cut by the punching section 21 is conveyed to the collecting section 22. The collecting section 22 collects the sheet 9 by winding the sheet 9 around the shaft core 23.

The post-processing device 4b includes the sheet feed section 20, the punching section 21, the collecting section 22, and the controller 25, similarly to the post-processing device 4a. The post-processing device 4b is different from the post-processing device 4a in a punching section 21. In other respects, the post-processing devices 4a and 4b have a common configuration.

The punching section 21 of the post-processing device 4b includes a curved surface cutting die 28. That is, the post-processing device 4a performs punching by using the curved surface cutting die 28. The curved surface cutting die 28 is installed, for example, on the surface of a rotatably driven roller, and rotates together with the rotation of the roller. The controller 25 cuts the images printed on the sheet 9 by rotationally driving the curved surface cutting die 28 in synchronization with the conveyance of the sheet 9 without stopping the conveyance of the sheet 9. For example, as the sheet 9 is conveyed in the conveyance direction F, the curved surface cutting die 28 cuts out the images printed on the sheet 9 one by one. Based on the reference mark 51 detected by the mark detection sensor 24, the controller 25 determines the timing for starting the rotation of the curved surface cutting die 28. This timing defines the cutting accuracy in the post-processing device 4b.

Since the post-processing device 4a uses the flat plate-shaped cutting die 27, it is possible to increase the cutting accuracy as long as the reference mark 51 is present in the center of the image which is a target of the punching process. In addition, since the post-processing device 4b uses the curved surface cutting die 28, it is possible to increase the cutting accuracy as long as the reference mark 51 is present on the leading end side of the image which is a punching processing target.

FIGS. 2A and 2B illustrate printing positions of the reference marks 51 by the image forming apparatus 3. FIG. 2A illustrates an example in which the reference mark 51 is printed on the leading end side of the image 50 in the conveyance direction F of the sheet 9. In FIG. 2A, three images 50a, 50b, and 50c are formed on the long sheet 9 at regular intervals, and three reference marks 51a, 51b, and 51c are formed on the leading end side of each of the images 50a, 50b, and 50c. The reference marks 51a,51b, and 51c are marks printed in addition to the images 50a, 50b, and 50c, respectively. Although FIG. 2A illustrates the case where the three images 50a, 50b, and 50c are added to reference marks 51a, 51b, and 51c, respectively, the present invention is not limited to this. For example, one reference mark 51 may be added to two or more images 50 and printed.

FIG. 2B shows an example in which the reference mark 51 is printed at the center of the image 50 in the conveyance direction F of the sheet 9. In FIG. 2B, three images 50a, 50b, and 50c are formed on the long sheet 9 at regular intervals, and three reference marks 51a, 51b, and 51c are formed at the center positions of the respective images 50a, 50b, and 50c. The reference marks 51a, 51b, and 51c are marks printed in addition to the images 50a, 50b, and 50c, respectively. Although FIG. 2B illustrates the case where the reference marks 51a, 51b, and 51c are added to the three images 50a, 50b, and 50c, respectively, the present invention is not limited to this. For example, one reference mark 51 may be added to two or more images 50 and printed.

The image forming apparatus 3 is capable of printing the reference mark 51 in addition to the image 50 to be printed on the sheet 9 as described above. The image forming apparatus 3 can print the reference mark 51 on the leading end side of the image 50 as shown in FIG. 2A, and can also print the reference mark 51 at the center of the image 50 as shown in FIG. 2B. Note that the image forming apparatus 3 can also print the reference mark 51 at positions other than the positions illustrated in FIG. 2A and FIG. 2B.

For example, when the reference mark 51 is printed at the center of the image 50 as shown in FIG. 2B, the post-processing device 4a can temporarily stop the conveyance of the sheet 9 by aligning the reference mark 51 with the center position of the flat plate-shaped cutting die 27. As a result, the post-processing device 4a can cut out the central portion of the image 50 by the flat plate-shaped cutting die 27. Therefore, in a case where the post-processing is performed by the post-processing device 4a, when the reference mark 51 is printed in the center of the image 50 as in FIG. 2B, the cutting accuracy by the flat plate-shaped cutting die 27 can be increased.

Further, for example, in a case where the reference mark 51 is printed on the leading end side of the image 50 as shown in FIG. 2A, the post-processing device 4b determines the timing of rotating the curved surface cutting die 28 based on the timing at which the reference mark 51 is detected by the mark detection sensor 24. As a result, the post-processing device 4b can rotate the curved surface cutting die 28 in accordance with the timing at which the image 50 is conveyed to the trimming position by the curved surface cutting die 28, and can accurately cut out the portion of the sheet 9 on which the image 50 is printed. Therefore, in a case where the post-processing is performed by the post-processing device 4a, when the reference mark 51 is printed on the side of the leading end of the image 50 as in FIG. 2A, the cutting accuracy by the curved surface cutting die 28 can be increased.

The control device 2 comprehensively controls operation in the image forming system 1. The control device 2 controls execution of a job in the image forming system 1 based on an operation by a user. For example, when it is designated to perform the post-processing on the sheet 9 on which the image is formed in the image forming apparatus 3, the control device 2 determines the printing position of the reference mark 51 according to the type of the post-processing. Next, the control device 2 instructs the image forming apparatus 3 on the printing position of the reference mark 51.

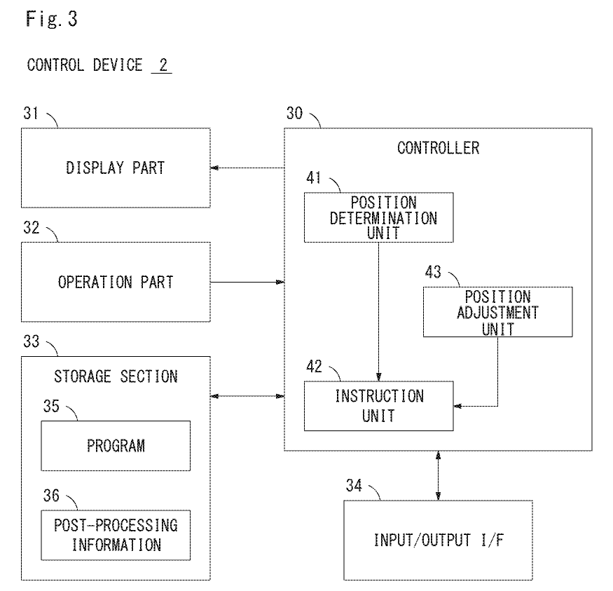

FIG. 3 is a diagram illustrating a hardware configuration and a functional configuration of the control device 2. The hardware configuration of the control device 2 includes a controller 30, a display part 31, an operation part 32, a storage section (storage) 33, and an input/output interface 34. The controller 30 includes a hardware processor (not shown). The hardware processor reads and executes the program 35 stored in the storage section 33. The display part 31 is configured by, for example, a color liquid crystal display, and displays various operation screens. The operation part 32 includes a keyboard, a mouse, and the like, and receives an operation inputted by a user. The storage section 33 is a nonvolatile storage device, for example, a hard disk drive (HDD) or a solid state drive (SSD). The storage section 33 stores post-processing information 36 in addition to the program 35. The post-processing information 36 is information in which the post-processing devices 4a and 4b connected to the image forming system 1 are registered. The input/output interface 34 is an interface that connects the control device 2 to the image forming apparatus 3 and the post-processing device 4 and communicates with these apparatuses.

The hardware processor of the controller 30 causes the controller 30 to function as a position determination unit 41, an instruction unit 42, and a position adjustment unit 43 by executing the program 35.

The position determination unit 41 functions in a case where post-processing is designated to be performed on the sheet 9 on which an image is formed in a job setting operation by a user. The position determination unit 41 determines the printing positions of the reference mark 51 based on the type of post-processing specified by the user. That is, the position determination unit 41 determines whether the reference mark 51 is to be printed on the leading end side of the image 50 or the center of the image 50 in the conveyance direction F of the sheet 9. The types of post-processing include first punching processing type using the flat plate-shaped cutting die 27 and second punching processing type using the curved surface cutting die 28. Next, when the type of the post-processing is the first punching processing type using the flat plate-shaped cutting die 27, the position determination unit 41 determines the printing position of the reference mark 51 so as to be on the center of the image 50. Furthermore, when the type of the post-processing is the second punching processing type using the curved surface cutting die 28, the position determination unit 41 determines the printing position of the reference mark 51 so as to be on the leading end side of the image 50.

The printing position of the reference mark 51 determined by the position determination unit 41 may be finely adjusted by the user. In that case, the position determination unit 41 temporarily determines the printing position of the reference mark 51 based on the type of the post-processing. Next, the position determination unit 41 finally determines the printing position of the reference mark 51 based on the result of the fine adjustment by the user.

The instruction unit 42 instructs the image forming apparatus 3 to print the reference mark 51 on the basis of the printing positions determined by the position determination unit 41. When forming the image 50 on the sheet 9 by executing the job designated by the user, the image forming apparatus 3 adds the reference mark 51 to the image 50 and prints the reference mark 51 based on the instruction from the instruction unit 42. For example, in a case where the punching process using the flat plate-shaped cutting die 27 is designated by the user, the image forming apparatus 3 adds the reference mark 51 to the center of the image 50 in the conveyance direction F of the sheet 9, and prints the reference mark 51. On the other hand, the user designates the punching process using the curved surface cutting die 28, the image forming apparatus 3 adds the reference mark 51 to the leading end side of the image 50 in the conveyance direction F of the sheet 9, and prints the reference mark 51.

When determining the printing position of the reference mark 51, the instruction unit 42 notifies the post-processing device 4a or 4b designated by the user of the printing position of the reference mark 51. Thus, the post-processing device 4a or 4b can grasp the printing positions of the reference mark 51, and can determine the position at which the punching processing is to be performed on the sheet 9 in accordance with the detection of the reference mark 51 by the mark detection sensor 24.

A job designated by the user may be a job of forming a first image on a sheet 9, then additionally printing a second image on the first image, and performing post-processing on the sheet 9 on which the second image has been additionally printed. For example, the additional printing is performed for the purpose of imparting gloss to an image by printing a transparent image (second image) using a clear toner or the like over a color image (first image) using toners of the respective colors of Y, M, C, and K.

When additional printing is performed, the position determination unit 41 determines the printing position of the reference mark 51 with respect to the first image on the basis of the type of post-processing. Then, when the first image is printed in the image forming apparatus 3, the instruction unit 42 instructs to print the reference mark 51 at the print position determined by the position determination unit 41. As a result, the image forming apparatus 3 prints the reference mark 51 at the print position determined by the position determination unit 41 when printing the first image on the sheet 9. Thereafter, when the second image is additionally printed in the image forming apparatus 3, the instruction unit 42 instructs the printing position of the second image with reference to the printing position of the reference mark 51 added to the first image. As a result, the image forming apparatus 3 can print the second image to be superimposed on the first image.

The position adjustment unit 43 functions when additional printing is performed on the sheet 9. For example, the position adjustment unit 43 displays a position adjustment screen on the display part 31, and adjusts the printing position of the second image with reference to the position of the reference mark 51 on the basis of an operation by the user. When the printing position of the second image is adjusted by the position adjustment unit 43, the instruction unit 42 indicates the adjusted printing position to the image forming apparatus 3 as the printing position of the second image.

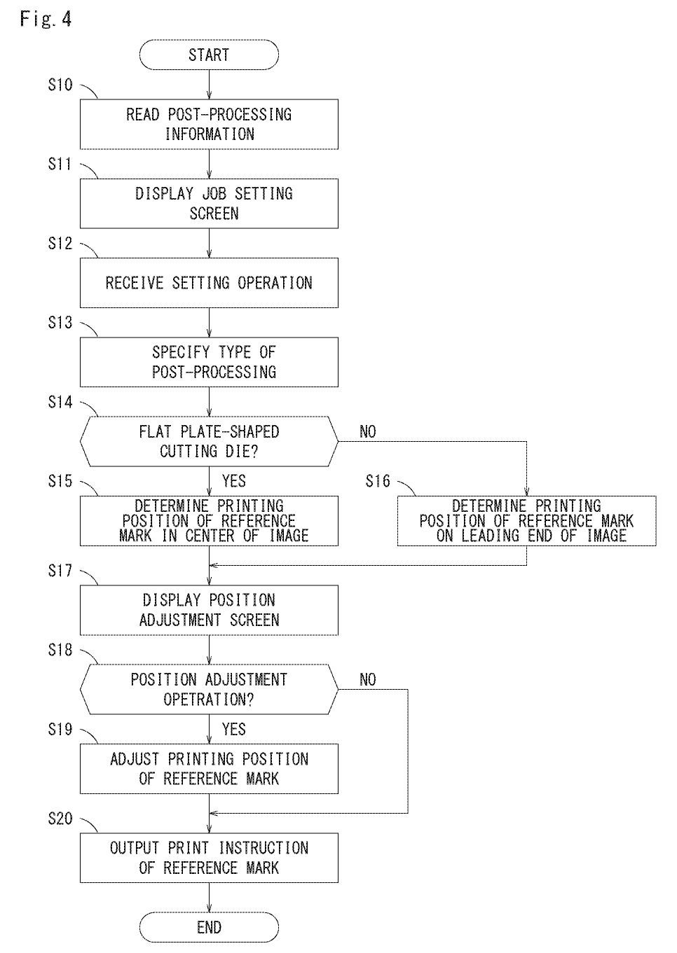

FIG. 4 is a flowchart illustrating an example of a processing procedure by the controller 30. FIG. 4 illustrates a processing procedure in a case where additional printing is not performed.

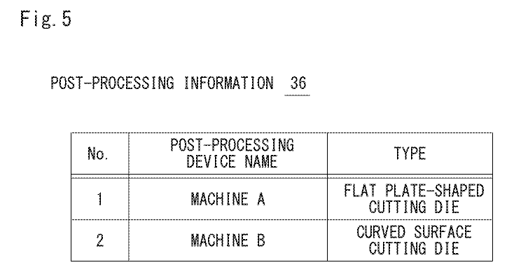

Upon start of the processing, the controller 30 reads the post-processing information 36 from the storage section 33 (step S10). FIG. 5 is a diagram illustrating exemplary post-processing information 36. The post-processing devices 4a and 4b illustrated in FIG. 1 are registered in the post-processing information 36 illustrated in FIG. 5. The post-processing information 36 is information in which device names of the post-processing devices 4a and 4b and types of post-processing are registered.

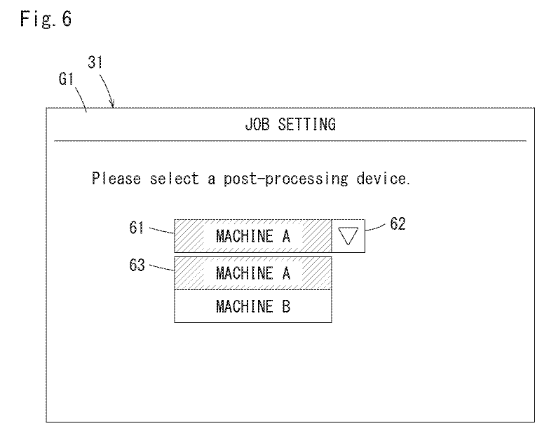

The controller 30 displays a job setting screen on the display part 31 (step S11) and receives a job setting operation by the user (step S12). At this time, when the user designates to perform the post-processing, the controller 30 displays a selection screen G1 of the post-processing device 4 as shown in FIG. 6 based on the post-processing information 36. The selection screen G1 illustrated in FIG. 6 includes a display field 61 for displaying the post-processing device 4 being selected. On the right side of the display field 61, an operation button 62 for displaying a pull-down menu 63 is displayed. When the operation button 62 is operated by the user, the controller 30 displays a pull-down menu 63. The pull-down menu 63 displays a list of the post-processing devices 4a and 4b registered in the post-processing information 36. The user can select the post-processing device 4 to perform post-processing from the displayed list.

When the post-processing device 4 is selected by the user, the controller 30 specifies the type of post-processing (step S13). The controller 30 determines whether the post-processing selected by the user uses the flat plate-shaped cutting die 27 (step S14). In a case where the post-processing uses the flat plate-shaped cutting die 27 (YES in step S14), the controller 30 determines the printing position of the reference mark 51 at the center of the image 50 to be printed on the sheet 9 (step S15). If the post-processing uses the curved surface cutting die 28 (NO in step S14), the controller 30 determines the printing position of the reference mark 51 at the leading end side of the image 50 to be printed on the sheet 9 (step S16).

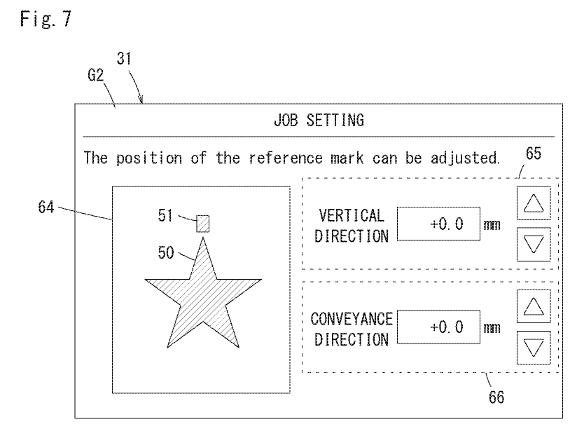

After temporarily determining the printing position of the reference mark 51, the controller 30 displays a position adjustment screen G2 as illustrated in FIG. 7 on the display part 31 (step S17). The position adjustment screen G2 illustrated in FIG. 7 is a screen for finely adjusting the printing position of the reference mark 51 with respect to the image 50. The position adjustment screen G2 includes a display area 64, a first operation area 65, and a second operation area 66. The display area 64 is an area for displaying a preview of the print position of the reference mark 51 with respect to the image 50. The first operation area 65 is an area for performing an operation of adjusting the printing position of the reference mark 51 in a direction orthogonal to the conveyance direction F of the sheet 9. The second operation area 66 is a region for performing an operation of adjusting the printing position of the reference mark 51 along the conveyance direction F of the sheet 9. When the position adjustment screen G2 is displayed, the user can finely adjust the printing position of the reference mark 51 with respect to the image 50 by performing an operation on the first operation area 65 or the second operation area 66 while viewing the display area 64. That is, the user can further enhance the cutting accuracy by the post-processing devices 4a and 4b by finely adjusting the printing position of the reference mark 51 in accordance with the characteristics of the post-processing devices 4a and 4b.

Upon displaying the position adjustment screen G2, the controller 30 determines whether a position adjustment operation has been performed by the user (step S18). When the position adjustment operation has been performed (YES in step S18), the controller 30 finely adjusts the printing position of the reference mark 51 determined based on the type of post-processing (step S19). In addition, in a case where the position adjustment operation is not performed by the user (NO in step S18), the controller 30 does not change the printing position of the reference mark 51 which is determined based on the type of post-processing.

Then, the controller 30 outputs a print instruction of the reference mark 51 to the image forming apparatus 3 based on the determined print position of the reference mark 51 (step S20).

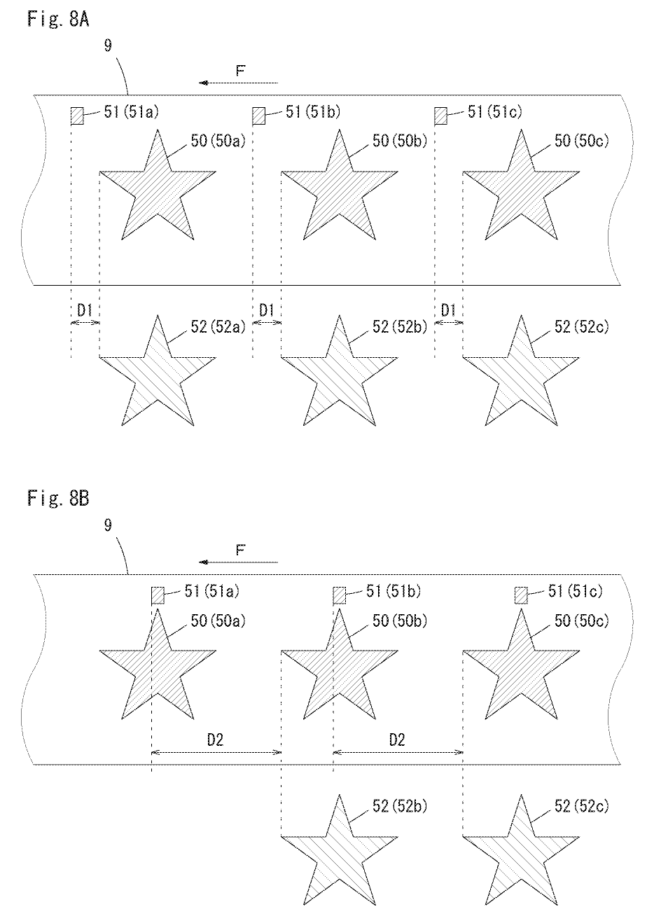

Next, a case where the second image is additionally printed so as to overlap the first image will be described. FIG. 8A and FIG. 8B are diagrams showing two patterns relating to additional printing. FIG. 8A shows a first pattern. The reference mark 51 is printed on the leading end side of the first image 50 in the first pattern. In the first pattern, when the second image 52 is additionally printed so as to be superimposed on the first image 50, the second image 52 can be superimposed on the first image 50 by starting the printing of the second image 52 at the position of the first distance D1 from the position of the reference mark 51.

Therefore, when the reference mark 51 are printed in the first pattern, the controller 30 instructs the image forming apparatus 3 to set, as the printing position of the second image 52, a position spaced from the reference mark 51 by the first distance D1. Thus, the image forming apparatus 3 prints the second image 52 at the position spaced from the printing position of the reference mark 51 by the first distance D1. As a result, in additional printing after the first image 50 is printed, the second image 52 can be superimposed on the first image 50.

FIG. 8B shows the second pattern. In the second pattern, a reference mark 51 is printed at the center of the first image 50. In the second pattern, when the second image 52 is additionally printed so as to be superimposed on the first image 50, the second image 52 can be superimposed on the first image 50 by starting the printing of the second image 52 at the position of the second distance D2 from the position of the reference mark 51. That is, in the second pattern, the second image 52 cannot be printed over the first image 50 (50a). Therefore, in the case of the second pattern, the second image 52 is printed so as to be superimposed on the second and subsequent first images 50 (50b and 50c).

When the reference marks 51 are printed in the second pattern, the controller 30 instructs the image forming apparatus 3 to set, as the printing position of the second image 52, a position separated from the reference marks 51 by the second distance D2. Thus, the image forming apparatus 3 prints the second image 52 at the position spaced from the printing position of the reference mark 51 by the second distance D2. As a result, in additional printing after the first image 50 is printed, the second image 52 can be superimposed on the first image 50.

In addition, when the printing position of the second image 52 is determined as described above, the controller 30 causes the position adjustment unit 43 to function. Then, the position adjustment unit 43 can adjust the printing position of the second image 52 with reference to the position of the reference mark 51 based on the operation by the user.

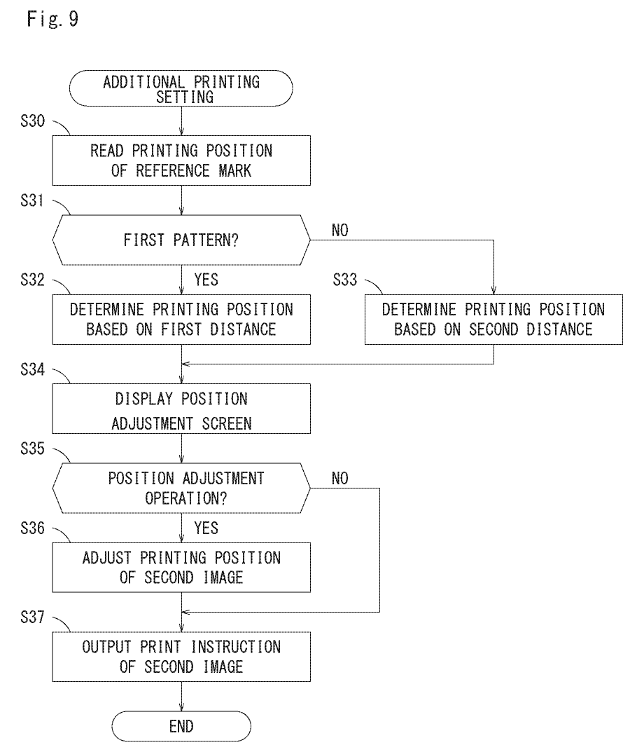

FIG. 9 is a flowchart illustrating an example of a processing procedure by the controller 30 in a case where additional printing is performed. In a case where additional printing is specified by the user, the controller 30 reads the printing position of the reference mark 51 determined on the basis of the type of post-processing (step S30). The controller 30 determines whether or not the printing position of the reference mark 51 is the first pattern described above (step S31).

In a case where the printing position of the reference mark 51 is the first pattern (YES in Step S31), the controller 30 determines the printing position of the second image 52 based on the first distance D1 (Step S32). In addition, in a case where the printing position of the reference mark 51 is the second pattern (NO in Step S31), the controller 30 determines the printing position of the second image 52 based on the second distance D2 (Step S33).

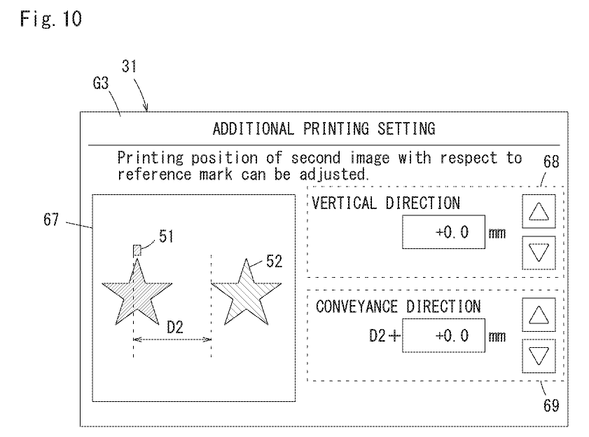

Next, the controller 30 allows the display part 31 to display a position adjustment screen G3 as illustrated in FIG. 10 (step S34). The position adjustment screen G3 shown in FIG. 10 is a screen for finely adjusting the printing position of the second image 52 with reference to the printing position of the reference mark 51. The position adjustment screen G3 includes a display area 67, a first operation area 68, and a second operation area 69. The display area 67 is an area for displaying a preview of the printing position of the second image 52 with respect to the reference mark 51. The first operation area 68 is an area for performing an operation of adjusting the printing position of the second image 52 in the direction orthogonal to the conveyance direction F of the sheet 9. The second operation area 69 is an area for performing an operation of adjusting the printing position of the second image 52 along the conveyance direction F of the sheet 9. When the position adjustment screen G3 is displayed, the user can finely adjust the printing position of the second image 52 with respect to the reference mark 51 by performing an operation on the first operation area 65 or the second operation area 66 while viewing the display area 67. That is, the user can perform adjustment so that the second image 52 appropriately overlaps the first image 50 by finely adjusting the printing position of the second image 52 in accordance with the characteristics of the image forming apparatus 3.

Upon displaying the position adjustment screen G3, the controller 30 determines whether a position adjustment operation has been performed by the user (step S35). When the position adjustment operation has been performed (YES in step S35), the controller 30 finely adjusts the printing position of the second image 52 (step S36). In addition, in a case where the position adjustment operation is not performed by the user (NO in step S35), the controller 30 does not change the printing position of the second image 52.

Then, the controller 30 outputs a print instruction of the second image 52 to the image forming apparatus 3 based on the determined print position of the second image 52 (step S37). Accordingly, in the image forming apparatus 3, the second image 52 is printed in a state of being superimposed on the first image 50. The image forming apparatus 3 that additionally prints the second image 52 on the sheet 9 may be an apparatus different from the image forming apparatus 3 that has printed the first image 50.

The sheet 9 on which the second image 52 is additionally printed is then set in the sheet feed section 20 of the post-processing device 4. Next, the post-processing device 4 is driven to perform post-processing on the sheet 9. Through the post-processing, the first image 50 on which the second image 52 is superimposed is punched out.

As described above, when the post-processing is performed on the sheet 9 on which the image 50 is formed, the control device 2 in the image forming system 1 determines the printing position of the reference mark 51 relative to the image 50. At this time, the control device 2 determines the printing position of the reference mark 51 on the basis of the type of the post-processing to be performed on the sheet 9. Therefore, the control device 2 can cause the reference mark 51 to be printed at a position where the accuracy of the post-processing does not decrease.

### MODIFICATION EXAMPLE

A preferred embodiment of the present invention has been described above. However, the present invention is not limited to the content described in the above embodiment, and various modification examples are applicable.

For example, in the above-described embodiment, the case where the reference mark 51 is added to each of the plurality of images 50 to be printed on the sheet 9 has been exemplified. However, the reference mark 51 may not be added to all of the plurality of images 50. For example, when determining the printing position of the reference mark 51, the controller 30 may determine the printing position at which the reference mark 51 is printed on at least one of the plurality of images 50.

In the above-described embodiment, the case where the plurality of images 50 is printed on the roll-shaped sheet 9 has been exemplified. However, it is not limited to this. For example, the image forming apparatus 3 may sequentially convey a plurality of sheets 9 one by one and print the image 50 on each sheet 9. In this case, the post-processing device 4 is also configured to convey the sheet 9 on which the image 50 is printed one by one and perform the post-processing on the sheet 9.

Furthermore, in the above-described embodiment, an example in which the control device 2 is configured as an apparatus separate from the image forming apparatus 3 has been described. However, the above-described configuration and functions of the control device 2 may be incorporated in the image forming apparatus 3.

Although embodiments of the present invention have been described and illustrated in detail, the disclosed embodiments are made for purposes of illustration and example only and not limitation. The scope of the present invention should be interpreted by terms of the appended claims.

What is claimed is:

1. A control device, comprising a controller that:
determines, in a case where post-processing is performed on a sheet on which an image is formed, a printing position of a reference mark with respect to the image; and
gives an instruction to print the reference mark based on the determined printing position, wherein
the controller determines the printing position of the reference mark based on a type of the post-processing.

2. The control device according to claim 1, wherein
the sheet is a rolled continuous sheet, and
the controller determines the printing position of the reference mark in a conveyance direction of the sheet.

3. The control device according to claim 2, wherein
a plurality of images is formed on the sheet along the conveyance direction of the sheet, and
the controller determines the printing position at which the reference mark is to be printed on at least one of the plurality of images.

4. The control device according to claim 2, wherein
the post-processing is processing of punching the image formed on the sheet, and
the type of the post-treatment is a first punching processing type using a flat plate-shaped cutting die or a second punching processing type using a curved surface cutting die.

5. The control device according to claim 4, wherein
the controller determines the printing position of the reference mark at the center of the image in a case where the type of the post-processing is the first punching processing, and determines the printing position of the reference mark at the leading end side of the image in a case where the type of the post-processing is the second punching processing.

6. The control device according to claim 1, wherein
a second image is formed on the sheet after a first image is formed, and
the controller determines a printing position of the reference mark with respect to the first image, instructs printing of the first image and the reference mark when the first image is formed on the sheet, and instructs a printing position of the second image with reference to the printing position of the reference mark when the second image is formed on the sheet.

7. The control device according to claim 6, wherein
the controller adjusts the printing position of the second image with reference to the printing position of the reference mark and instructs the printing position adjusted when the second image is formed on the sheet.

8. The control device according to claim 1, further comprising:
a storage that stores post-processing information on the post-processing, wherein
the controller determines the printing position of the reference mark based on the post-processing information stored in the storage.

9. The control device according to claim 1, wherein
the controller temporarily determines the printing position of the reference mark based on the type of the post-processing, displays a position adjustment screen for adjusting the temporarily determined printing position, and determines the printing position of the reference mark based on an operation performed on the position adjustment screen.

10. An image forming system, comprising:
the control device according to claim 1, and
an image forming apparatus that prints the image with the reference mark on the basis of the instruction from the control device when the image is formed on the sheet.

11. An image forming system, comprising:
the control device according to claim 1, and
a post-processing device that detects a position of the reference mark printed on the sheet and determines a position at which the post-processing is performed when the post-processing is performed on the sheet.

12. An image forming system according to claim 10, further comprising:
a post-processing device that detects a position of the reference mark printed on the sheet and determines a position at which the post-processing is performed when the post-processing is performed on the sheet.

13. A control method of an image forming system, comprising:
determining a printing position of a reference mark with respect to an image in a case where post-processing is performed on a sheet on which the image has been formed; and
instructing printing of the reference mark on the basis of the determined printing position, wherein
the printing position of the reference mark is determined on the basis of the type of the post-processing.

14. The control method according to claim 13, wherein
the sheet is a rolled continuous sheet, and
the control method determines the printing position of the reference mark in a conveyance direction of the sheet.

15. The control method according to claim 14, wherein
a plurality of images is formed on the sheet along a conveyance direction of the sheet, and
the control method determines the printing position at which the reference mark is to be printed on at least one of the plurality of images.

16. The control method according to claim 14, wherein
the post-processing is processing of punching the image formed on the sheet, and
the type of the post-treatment is a first punching processing type using a flat plate-shaped cutting die or a second punching processing type using a curved surface cutting die.

17. The control method according to claim 16, wherein
the control method determines the printing position of the reference mark at the center of the image in a case where the type of the post-processing is the first punching processing, and determines the printing position of the reference mark at the leading end side of the image in a case where the type of the post-processing is the second punching processing.

18. The control method according to claim 13, wherein
a second image is formed on the sheet after a first image is formed, and
the control method determines a printing position of the reference mark with respect to the first image, instructs printing of the first image and the reference mark when the first image is formed on the sheet, and instructs a printing position of the second image with reference to the printing position of the reference mark when the second image is formed on the sheet.

19. The control method according to claim 18, further comprising:
adjusting the printing position of the second image with reference to a printing position of the reference mark.

20. The control method according to claim 13, further comprising:
storing post-processing information on the post-processing in a storage, wherein
the control method determines the printing position of the reference mark based on the post-processing information stored in the storage.
